(19) United States
(12) Patent Application Publication
(10) Pub. No.: US 2015/0177842 A1
(43) Pub. Date: Jun. 25, 2015

(54) 3D Gesture Based User Authorization and Device Control Methods

(71) Applicant: Yuliya Rudenko, Alexandria, VA (US)

(72) Inventor: Yuliya Rudenko, Alexandria, VA (US)

(21) Appl. No.: 14/139,382

(22) Filed: Dec. 23, 2013

(51) Int. Cl. G06F 3/01; G06T 7/60; G06K 9/00

(52) U.S. Cl. CPC G06F 3/017; G06K 9/00355; G06T 7/606; G06T 2207/20076; G06T 2207/30196

(57) ABSTRACT

Systems and methods are described that provide for user authentication, access to data or software applications and/or control of various electronic devices based on hand gesture recognition. The hand gesture recognition can be based on acquiring, by an HD depth sensor, biometrics data associated with user hand gesture including 3D coordinates of virtual skeleton joints, user finger and/or finger cushions. The biometrics data can be processed by machine-learning algorithms to generate an authentication decision and/or a control command. The authentication decision and/or control command can be used to activate a user device, run software or provide access to local or online resources.

### TECHNICAL FIELD

This technology relates generally to human-computer interaction and, more specifically, to the technology of recognizing three-dimensional (3D) hand gestures for user authentication, providing access to data or software applications and/or controlling various electronic devices.

### BACKGROUND

Traditional biometrics-based user authentication systems may acquire user biometric data for making authorization decisions. The biometrics data may refer, for example, to keystroke dynamics, face images, retina images, iris images, and fingerprints. These authentication systems may still not provide reliable and guaranteed authentication. There is a continuing need for improving the user authentication process such as by decreasing the false acceptance rate (FAR) and false rejection rate (FRR).

### SUMMARY

Various embodiments provide generally for significantly improving the user authentication process, decreasing the false acceptance rate (FAR) and false rejection rate (FRR). The present technology may be further used to control electronic devices or to provide access to data and/or enable running certain software applications for use by a user.

According to one or more embodiments, there is provided a method for user authentication. At least one preferred embodiment provides for a method comprising a step of acquiring biometrics data of a user. The biometrics data can be associated with hand gestures made by a user in proximity of a sensor. The sensor can refer to a depth sensitive device such as a high definition (HD) depth sensor, 3D sensor, stereoscopic cameras, and/or another manner of depth sensing device. In some embodiments, the sensor may also comprise a digital video camera. In some embodiments, the sensor can be, or can be integrated with or can include, a touchscreen, touchpad or any other sensing pad configured to detect a user's hand in proximity of its surface. In certain embodiments, the sensor may be a part of a user device or may be operatively coupled to a user device using any suitable methodology.

In general, according to one or more embodiments of the invention, the biometrics data can include data related to a hand shape and modification of the hand shape over a period of time. In certain embodiments, the sensor can capture a series of “images” (e.g., without limitation, graphical images, depth maps, electromagnetic maps, capacitive maps, or other images or image mappings, depending on the type of the sensor) over a period of time during which the user makes the hand gesture. In one or more preferred embodiments, such images can constitute the biometrics data. In further embodiments of the invention, the images can be pre-processed to recognize in every image, without limitation: a shape of a user hand; a shape, dimensions and/or a posture of hand fingers; a shape, dimensions and/or a posture of hand finger cushions; and/or a shape and a posture of a hand palm.

At least one embodiment provides for the biometrics data further include, without limitation, one or more attributes associated with user hand gesture, the attributes including one or more of the following, without limitation: a velocity, an acceleration, a trajectory, and/or a time of exposure. The attributes may be associated with the user hand as a whole, or may be associated with one or more fingers, or one or more finger cushions (or nails), or any combination of the foregoing. One or more of these attributes can be referred to as “3D user-gesture data.” The terms “3D user-gesture data” and/or “3D gesture data” as used herein can include, without limitation, data related to hand shape or its modification, hand and/or finger locational or positional information, and/or hand-gesture attributes.

According to further embodiments of the invention, the biometrics data may further include positional data related to the entire hand and/or its parts. For example, the biometrics data may include positional data (e.g., 3D coordinates) related to one or more fingers. In one or more other embodiments, the biometrics data can include positional data (e.g., 3D coordinates) related to one or more finger cushions. The positional data can be tied to a 3D coordinate system, such as, for example, a rectangular 3D coordinate system, wherein two coordinates may coincide with a sensor's surface and/or have a zero point at the sensor's surface.

The biometrics data, according to one or more embodiments, can further include dimensional data related to the entire hand and/or its parts. For example, without limitation, biometrics data can include dimensions of fingers, distances between fingers or finger cushions, dimensions of the palm of the hand, distance between fingers or finger cushions and aspects of the palm and/or variations or combinations of such dimensional data. The biometrics data can also include dimension ratios, such as, for example, without limitation: a ratio of dimensions of two or more fingers; a ratio of distances between a first pair of finger cushions and a second pair of finger cushions; a ratio of distances between the first two cushions of a first finger and between the first two cushions of a second finger; and/or a ratio of distances between the first and second cushions of a finger and between the second and third cushions of the same finger.

According to one or more embodiments, the 3D user-gesture data can include data related to a number of different parameters and/or attributes including, without limitation, one or more of a shape, a posture, a position, a location within a 3D coordinate system; dimensions, or other spatial, locational or configurational features of the user hand or its parts (such as, for example, without limitation, the user's fingers or fingers' cushions), wherein said parameters and/or attributes can be discretely recorded or captured over a time period during which the user makes the gesture. In other words, the 3D user-gesture data can describe the way in which the user makes one or more hand gestures in the 3D space.

The present technology, according to further embodiments, can comprise a system, methods and/or a combination thereof that can provide for analyzing the 3D user-gesture data as acquired and optionally pre-processed by the sensor or a plurality of sensors, and then make an authorization decision based thereon. More specifically, the analysis of the 3D user-gesture data can comprise applying a machine learning algorithm to determine similarity between one or more features of the 3D user-gesture data and one or more reference features. Where certain reference features refer to pre-authorized (validated) users, an analysis component, module and/or step of at least one embodiment analyzes the 3D user-gesture data and determines whether the user, from whom the 3D user gesture was captured, is one of the pre-authorized users. In certain embodiments, the machine learning algorithm may provide calculation of a score or rank associated with the 3D user-gesture data. For example, the score may represent the similarity between one or more features of the 3D user-gesture data and one or more pre-stored reference features. Further, the analysis process may determine whether the score is close to, equal to, or whether it is above or below a particular predetermined value and, if so, then a positive authorization decision may be generated. Otherwise, a negative authorization decision may be generated. In either case, the machine learning algorithm may be trained with the 3D user-gesture data to improve reference features (also known as classifiers).

According to various embodiments, the machine learning algorithms used in association with an analysis component or module, and/or in association with an analysis step, may refer to one or more heuristic algorithms, one or more support vector machines, or one or more neural network algorithms, without limitation. When neural network algorithms are used, the analysis process may include the steps of receiving 3D user-gesture data, extracting one or more features (or feature vectors), determining similarity between the one or more features (or feature vectors) and one or more reference features (or reference feature vectors), calculating a score associated with the similarity, and determining what one or more reference features is/are the closest to the one or more features, and based on the score, an authentication decision can be made. It should be noted that the score may be based or relate to differential vector between the feature vector and the closest reference feature vector.

One or more embodiments provide for the authentication decisions can be used to provide or decline access for the user to certain data, hardware, or software. For example, the authentication decisions can be used to provide or decline access to a website. In another example, the authentication decisions can be used to enable the user to run a specific software or software application. In yet another example, the authentication decisions can be used to enable the user to operate (e.g., activate) a specific hardware, such as, for example, without limitation, a computer, a tablet computer, a wearable computing device, a mobile device, a cellular phone, a kiosk device, an automated machine (such as, for example, an automated teller machine), a gaming console, an infotainment device, or an in-vehicle computer. In various embodiments, the present technology can be used instead of or in addition to the need for the user to enter a PIN code or a password.

### BRIEF DESCRIPTION OF THE DRAWINGS

FIG. 1 is a high-level block diagram of a network environment suitable for implementing authentication and user device control methods of one embodiment of the invention, wherein a depth sensor is integrated with a user device.

FIG. 2 is a high-level block diagram of another network environment suitable for implementing authentication and user device control methods of one embodiment of the invention, wherein a depth sensor is separated from a user device.

FIG. 3 is a high-level block diagram of yet another network environment suitable for implementing authentication and user device control methods of one embodiment of the invention, wherein a depth sensor and an authentication system is integrated with a user device.

FIG. 4 is a high-level block diagram of a user device according to one embodiment of the invention.

FIG. 5 is a high-level block diagram of an authentication system according to one embodiment of the invention.

FIG. 6 is a series of images captured by a sensor or a camera showing one example of a hand gesture in accordance with one embodiment of the invention.

FIG. 7 is a series of images captured by a sensor or a camera showing another example of a hand gesture in accordance with one embodiment of the invention.

FIG. 8 is a series of images captured by a sensor or a camera showing one example of a hand gesture and its associated 3D skeleton patterns in accordance with one embodiment of the invention.

FIG. 9 is a series of images captured by a sensor or a camera showing one example of a hand gesture and associated positions of finger cushions in accordance with one embodiment of the invention.

FIG. 10A is an illustration of a user hand and a corresponding virtual skeleton associated therewith, showing an example of 3D coordinates related to various skeleton joints, which coordinates, in turn, are associated with corresponding parts of the user hand, in accordance with one embodiment of the invention.

FIG. 10B is an illustration of a user hand and a corresponding 3D coordinates related to finger cushions of the user hand in accordance with one embodiment of the invention.

FIG. 11 is a process flow diagram illustrating a method of user authentication based on 3D user-gesture data in accordance with one embodiment of the invention.

FIG. 12 is a process flow diagram illustrating a method of controlling an electronic device based on 3D user-gesture data in accordance with one embodiment of the invention.

FIG. 13 is a process flow diagram illustrating another method for user authentication based on 3D user-gesture data in accordance with one embodiment of the invention.

FIG. 14 is a process flow diagram illustrating a method for training a machine learning algorithm upon receipt of 3D user-gesture data in accordance with one embodiment of the invention.

FIG. 15 is a diagrammatic representation of an example machine in the form of a computer system within which a set of instructions for the machine to perform any one or more of the methodologies discussed herein is executed.

### DETAILED DESCRIPTION

The foregoing Summary can now be augmented and one or more preferred embodiments of the invention can be further described and understood by the more detailed description and specific reference to the accompanying drawings presented in the following paragraphs.

The following detailed description includes references to the accompanying drawings, which form a part of the detailed description. The drawings show illustrations in accordance with example embodiments. These example embodiments, which may also be referred to herein as “examples,” are described in enough detail to enable one of ordinary skill in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

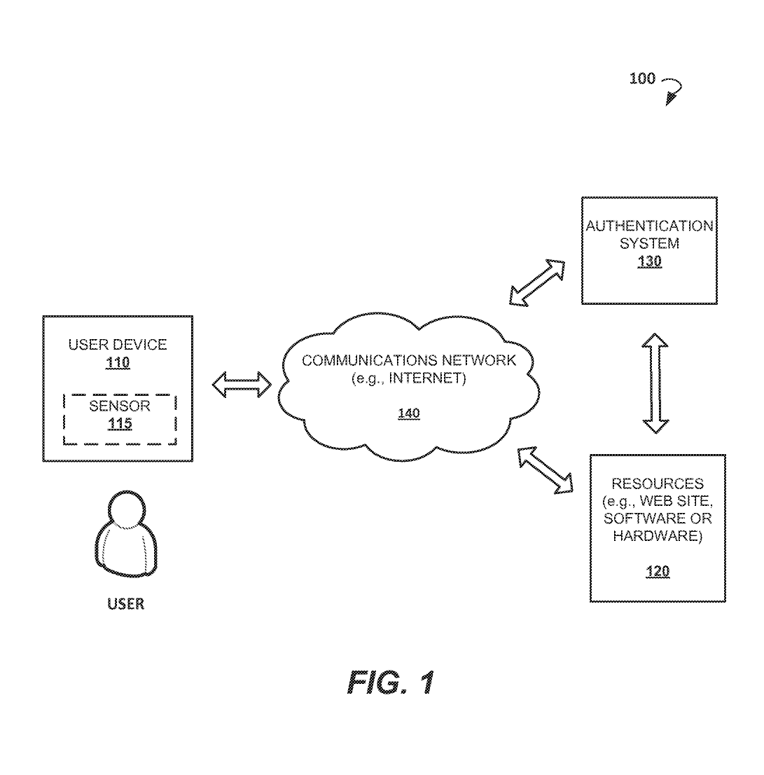

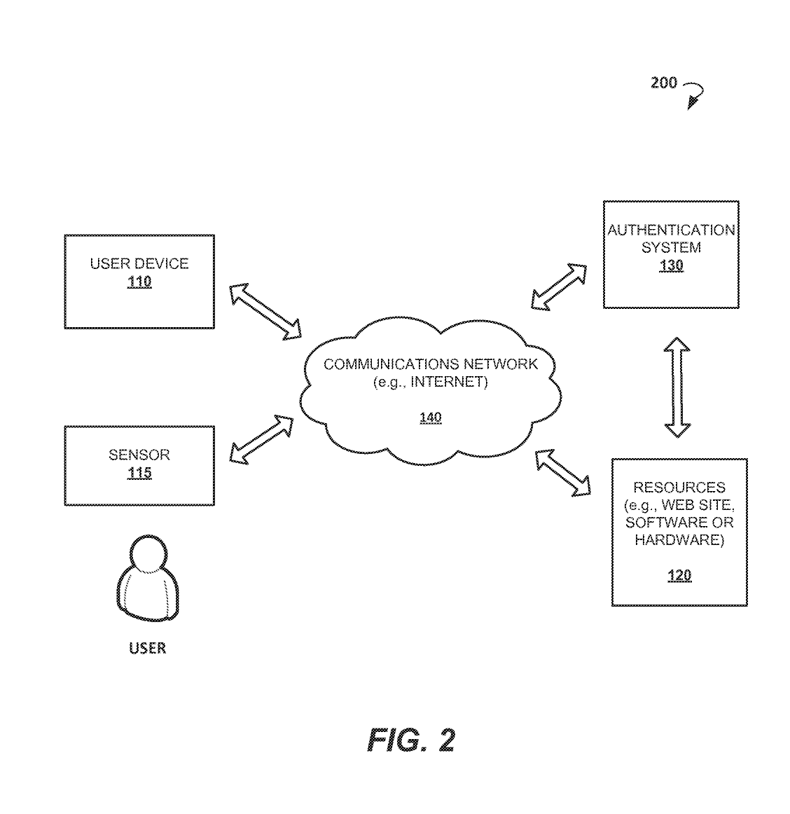

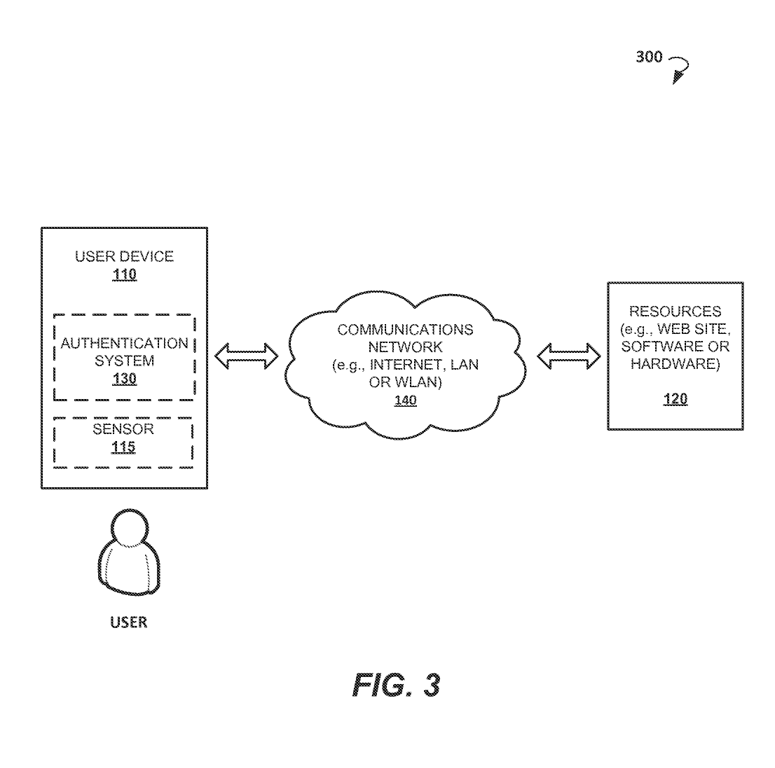

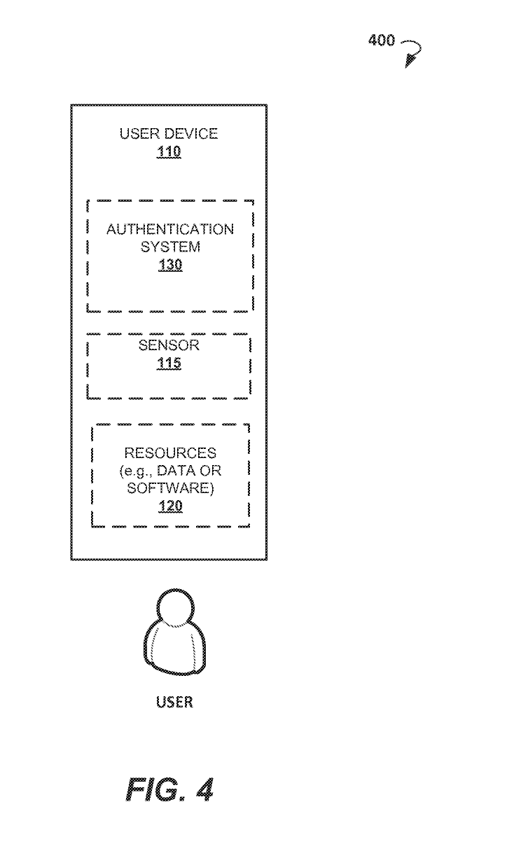

The present technology can be implemented in a client-server environment (FIG. 1 and FIG. 2) or entirely within a client side (FIG. 3 and FIG. 4) or it can be a distributed solution whereas some components run on a client side and some other components run on a server side (this embodiment is not shown). The term user “user device,” as used herein, may refer to a computer (e.g., a desktop computer, a laptop computer, a tablet computer, a wearable computer), a wireless telephone, a cellular phone, a smart phone, a gaming console, a TV set, a TV adapter, an Internet TV adapter, a cable modem, a media system, an infotainment system, an in-vehicle computing system, and so forth. The user device may include or be operatively coupled to a sensor to capture the 3D user-gesture data. As mentioned, the sensor may include a HD depth sensing device, HD 3D camera, stereoscopic cameras, a touchscreen, a touchpad, a video camera(s) or any other device configured to capture detect and recognize user hand gestures made in its proximity.

With reference to FIG. 1-FIG. 4 one or more preferred embodiments provide for an authentication system comprising a user device 110 (such as, for example, without limitation, a computer, user terminal, cellular phone, tablet computer, or other device), a sensor 115 (such as, for example, without limitation, a HD 3D depth sensor or related device), one or more resources 120 (such as, for example, without limitation, web (remote) resources, local resources, a web site, server, software and/or hardware platform), an authentication system 130 (which can be configured to acquire data from the sensor 115, process the data and generate an authentication decision based thereupon and on one or more of the methods described herein), and a communications network 140 (such as, for example, without limitation, the Internet, a local area network, an Ethernet-based network or interconnection, a Bluetooth-based network or interconnection, a wide area network, a cellular network, and so forth).

According to one or more further embodiments, the present technology can also be used to generate certain control commands for the user device 110 or any other electronic device. In other words, the present technology may acquire 3D user-gesture data, analyze it using one or more machine learning algorithms as described above, determine a gesture type, optionally authorize a user based thereupon, and generate a control command corresponding to the gesture. In at least one example, the control command can be of awakening an electronic device from an idle state into an operational state. For example, the user in possession of a tablet computer may need to perform an “unbending fingers” or “finger snap” motion in front of the tablet computer such that the tablet computer becomes active and/or unlocked. This can be much simpler and/or faster than finding a physical button and pressing it on the tablet computer and then entering a pin code. The technology may also recognize the type of gesture and generate an appropriate, corresponding command. For example, one gesture, when recognized, may be used to authenticate the use and turn on a user device, and another gesture may be used to run specific software or provide access to specific data or resources (e.g., local or online resources).

FIGS. 1-3 illustrate examples of systems, having related methods described herein, which according to one or more embodiments can be used for authenticating a user and/or controlling devices based upon a user hand gesture. If a user wants to activate a device that is in an idle state, for example, then the user can make a predetermined hand gesture in front of the sensor 115. The gesture is captured by the sensor 115, which transfers data to the remotely located authentication system 130 (based on the example shown in FIG. 1). The authentication system 130 processes the depth images (depth maps) and retrieves 3D gesture data, which may include a series of 3D coordinates associated with a virtual skeleton joints or a series of 3D coordinates associated with finger cushions, or similar/related information. The 3D gesture data are then processed to generate a feature vector (e.g., the processed data result can be simply a vector of coordinates). The feature vector (which can be termed a “first feature vector”) then can be compared to a number of reference feature vectors (which can be termed “second, reference feature vectors”), which are associated with multiple users. Machine learning algorithms enable determining similarity values between a first feature vector and each of the plurality of second, reference feature vectors (which similarity value, or representation, can be as simple as a difference vector between a first vector and a second vector). The authentication system 130 may then select the reference feature vector that is the most similar to the just generated feature vector. If the similarity value (also referred herein as to a score or rank) is above a predetermined threshold, then the authentication system 130 determines that the feature vector relates to a pre-validated user that is associated with the most similar feature vector. Thus, the user is authenticated. Otherwise, the user is not authenticated. If the user is successfully authenticated, the authentication system 130 generates a positive authentication decision (e.g., as simple as a predetermined message) and sends it back to the user device 110. Upon receipt of the positive authentication decision, the user device 110 may be activated, i.e., turned from the idle state into an active state. In other words, the user may perform a 3D gesture in front of the user device being an inactive state and, once the gesture is processed, the user may be first authenticated and, if the authentication is successful, then a control command may be generated to activate (“wake up”) the user device. In other examples, the control command may be sent out to another user device (e.g., without limitation, a TV or gaming console).

Similar processes can be used to control software and/or hardware in alternative embodiments. In a second example, a user may want to start a video game application on his or her user device 110. Similar to the above described approach, the user can provide a hand gesture, which is then processed by the authentication system 130. The authentication system 130 makes a decision and if the user is authorized, the authentication system 130 sends to the user device 110 a message allowing the user device 110 to run or activate the wanted video game application. It should also be appreciated that some embodiments can provide for systems and/or methods that comprise integral parts of and/or control systems for an “intelligent house” or “smart home” and which systems and/or methods may be used as part of home automation or control systems.

In yet a third example of a preferred embodiment, the user may want to visit a specific web site 120 (such as, for example, without limitation, a social network). Some websites require that users provide a PIN or password to be able to get access to their profiles, specific content, or other online data. Instead of inputting a password, which is vulnerable to being stolen or discredited, the user can make a predetermined hand gesture. Similar to the foregoing, the remotely located authentication system 130 makes an authentication decision and sends it to the web site 120. In alternative embodiments, the web site 120 can comprise an online platform or web application. If the authentication decision is a positive one, the user gets access to his profile or other online data.

FIG. 1 and FIG. 2 show implementations in which the authentication system 130 is remote to the user device 110. In at least one preferred embodiment, such a system configuration is preferable in order to keep the more complex and heavier proprietary algorithms outside of a simple electronic user device 110 (such as, for example, without limitation, a cellular phone user device). In such examples, it is also easier to maintain and update software and reference databases of the authentication system 130. In other preferred embodiments, however, the authentication system 130 may be integrated with the user device 110, if the user device's resources are sufficient to process biometrics data.

FIG. 4 shows an example of an embodiment that provides for a user device 110 that integrates the modules discussed above, namely the authentication system 130 (implemented in software/firmware codes), the sensor 115 (hardware element), and resources 120, which resources the user can access if the authentication system 130 successfully authorizes the user.

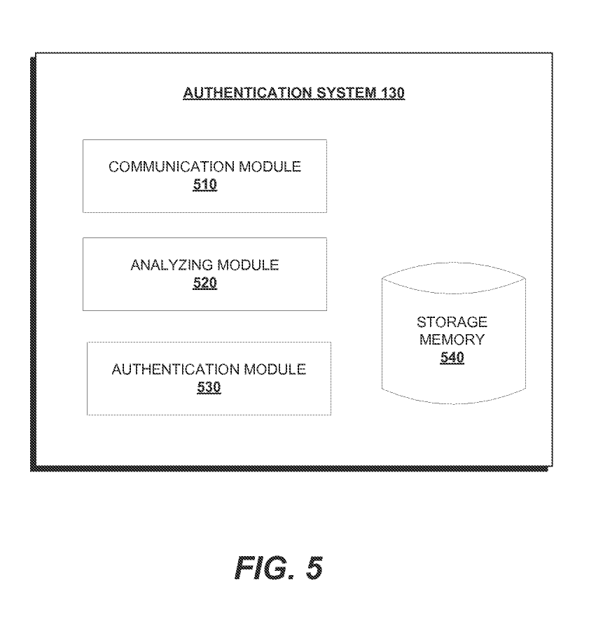

Referring to FIG. 5, the authentication system 130 can be implemented in a client-server environment, on a client side only, or a combination of both. The authentication system 130 may be implemented as software/firmware, hardware, or a combination of both. In case of software, in one or more embodiments, there can be corresponding processor-executable codes stored on a non-transitory machine-readable medium. In one preferred embodiment, the authentication system 130 can include a communication module 510, an analyzing module 520 (which uses machine learning algorithms), authentication module 530, and a storage memory 540, all of which are interoperably and/or intercommunicably connected. The authentication may be performed in real time. The communication module 510 is configured to receive data from the sensor 115 and send positive or negative authentication decisions to the user device 110, online or local resources 120, or to other agents. The analyzing module 520 can be configured to process data received from the sensor 115, which can comprise, in turn, retrieving one or more first feature vectors, compare the first feature vector(s) to second, reference feature vectors, and calculate a similarity value (score) based thereupon. The authentication module 530 is configured to generate a positive or negative authentication decision based upon the similarity value (score). The authentication module 530 can be also configured to generate a control command, namely a command to active a device from an idle state, a control command to run a dedicated software code, or a control command to provide access to specific resources. The storage memory 540 stores computer-executable instructions enabling the authentication system 130 to operate, reference feature vectors, machine learning algorithms' parameters, and so forth.

The 3D user-gesture data can be collected with respect to various user hand gestures. Some examples of user gestures can include, without limitation: making a first motion (i.e. bending fingers); releasing a first into a hand posture with splayed fingers; making a rotational motion of an arm/palm around its axis; making a circle motion with a hand or one or more fingers; moving a straightened hand towards the sensor or outwardly from the sensor; finger snap motion; wave finger motion; the motions of making an input via a keyboard or touchscreen, making a motion of moving a hand towards a sensor or touchscreen, and/or any combination of the foregoing.

In other words, in case a user wants to use a particular user device, the user may need to perform a predetermined hand gesture such that it can be captured by the sensor(s) 115. One or more embodiments of the present technology can take advantage of a strong probability that all people have different “muscle memory,” different hand shapes, different dimensions of various fingers, and/or, generally speaking, that the motions of two people cannot be precisely and/or exactly equal. Once the user hand gesture is captured and recognized, there can be provided access to data, software, or a device itself.

According to one or more embodiments, an authentication system may be configured to acquire depth values by one or more depth sensing devices being enabled to generate a depth map in real time, optionally with the help of one or more video cameras. In some embodiments, the depth sensing device may include an infrared (IR) projector to generate modulated light and also an IR camera to capture 3D images. In further preferred embodiments, a gesture recognition authentication and/or control system may comprise a color video camera to capture a series of 2D images in addition to 3D imagery created by a depth sensing device. The depth sensing device and the color video camera can be either stand alone devices or be encased within a single housing. Preferred embodiments may utilize depth-sensing sensors that employ, without limitation, depth sensing by triangulation or by time-of-flight (TOF).

Further embodiments can provide for a computing device having processors to be operatively coupled to or embed the depth sensing sensor(s) and/or video camera(s). For example, with reference to FIG. 1-FIG. 4, the sensor 115 can be controlled by a processor of the user device 110. The depth map can be then analyzed by a further computing unit (such as, for example, as in FIG. 5, an analyzing module 520, which module can be associated with or part of an authentication system 130) in order to identify whether or not a user hand and/or finger(s) is/are presented on the depth map. If the user hand and/or fingers(s) is or are located within the monitored area, an orientation of the user hand and/or fingers(s) can be determined based on position of the user hand and/or fingers(s).

In some embodiments, a virtual three-dimensional sensing zone can be established in front of the sensor or depth sensing device. This virtual sensing zone can be defined as a depth range arranged at a predetermined distance from the sensor or depth sensing device towards the user or any other predetermined location. One or more embodiments can provide for the sensing zone to be from 0.1 mm to 5 meters from the user device and/or sensor surface, and one or more preferred embodiments can provide for the sensing zone to be preferably 0.1 mm to 1000 mm from the device and/or sensor surface. More preferably the range of the sensing zone is 10 mm to 300 mm from the device and/or sensor surface, particularly for smaller-scale applications or situations (such as, for example, without limitation, tablet computers). For larger-scale applications, the range can be preferably 0.5 to 5 meters.

In one or more embodiments, a cubical-shape virtual sensing zone can be created and associated with the user and/or the user hand or finger(s) in front of the sensor 115. In some examples, the computing device can further analyze only those hand gestures which are made by the user hand and/or fingers(s) within this virtual sensing zone. Further, the virtual sensing zone can be defined by particular location and dimensions. The virtual sensing zone may comprise a virtual cube, a parallelepiped, or a truncated parallelepiped.

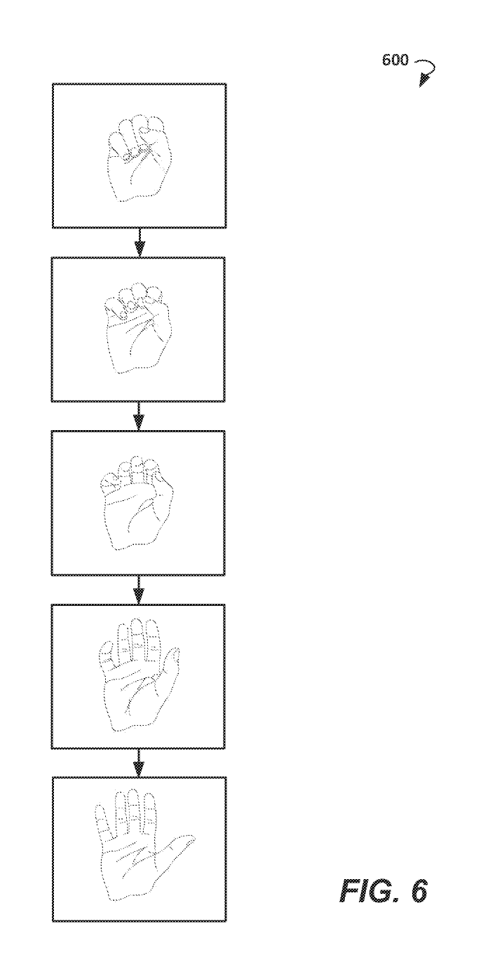

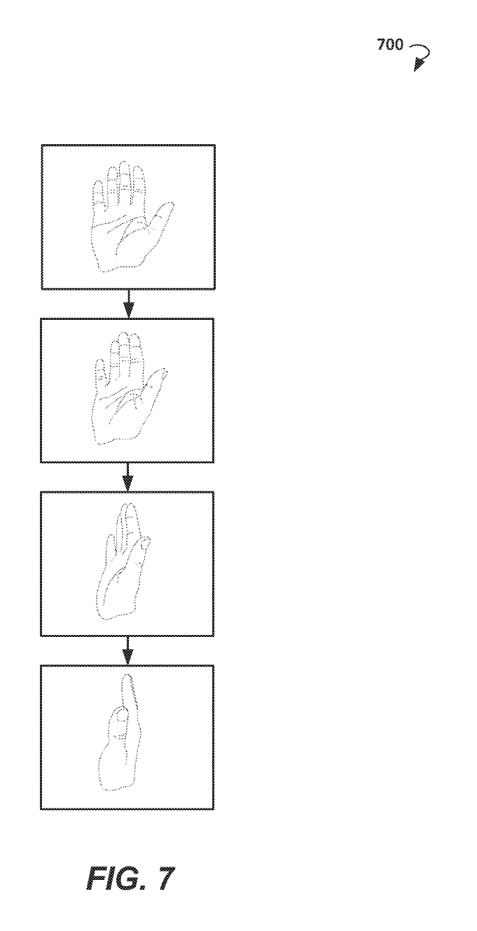

In an example of one or more embodiments, for example, in order to be authorized, a user may need to make a 3D hand gesture of unbending fingers of the hand and making them splayed. While the user is making the gesture, the sensor 115 makes a series of “snapshots”, images, depth maps, or other optical data capture, with respect to the user's gesture. FIG. 6 and FIG. 7 each illustrate a series of snapshots captured by the sensor 115 or a camera, with each series showing one example of a hand gesture in accordance with at least one embodiment of the invention. FIG. 6 illustrates a series of snapshots captured by the sensor 115 with respect to the gesture of “releasing a first into a hand posture with splayed fingers”. This series of snapshots would typically be captured sequentially over a certain interval of time. FIG. 7 shows a further example of such snapshots with respect to the gesture of “making a rotational motion of an arm/palm around its axis”. It will be appreciated, however, that these are merely two of many possible examples of hand gestures that can be made by users in front of a sensor for authentication purposes and/or for controlling of electronic devices or software applications or to get access to data storage.

Various embodiments can have sensor capture events at differing time intervals. Capture events per second can be termed “frame rate per second” (fps). A wide range of frame rates can be used. One or more embodiments can use frame rates in the range of 24 to 300 fps, while at least one preferred embodiment can utilize frame rates in the range of 50-60 fps.

As mentioned above, according to at least one embodiment, the sensor can be either integrated into an electronic device or can be a stand alone device. One or more embodiments may optionally utilize “motion detector or triggers,” which can have utility to save power. A high-density (HD) depth sensor, according to one preferred embodiment can use an infra-red projecting device and a high-density charge couple device (HD CCD) matrix to capture reflected IR light. Those of ordinary skill in the art will appreciate that, as well, in alternative embodiments, stereoscopic cameras can be used, or any other device capable of image capture (such as, for example, a Complementary Metal Oxide Semiconductor (CMOS) image sensor with active-pixel amplification).

Every snapshot or image may be pre-processed to retrieve one or more features associated with the 3D user hand gesture. In a simple embodiment, the feature may include a matrix or a vector comprising data characteristic to a given snapshot. For example, the matrix may include a set of 3D coordinates related to every finger cushion or a set of 3D coordinates related to a virtual skeleton of user hand. However, the features may include a wide range of information. That said, the features of a single snapshot may be associated with one or more of the following: a hand posture, a hand shape, fingers' postures, fingers' positions (i.e., 3D coordinates), finger cushions' postures, finger cushions' positions (i.e., 3D coordinates), angles between fingers, rotational angles of hand palm, a velocity of motion of one or more fingers or hand, acceleration of motion of one or more fingers or hand, dimensions of fingers, lengths between various finger cushions, and/or other aspects or manners of hand and/or finger configuration and/or movement. The features may be extracted and combined together into feature vectors. For example, for a series of snapshots representing a hand gesture, a feature vector can be created, which includes multiple features combined from every captured snapshot from the series. In general, a plurality of features or feature vectors related to multiple images (snapshots) can constitute 3D user-gesture data.

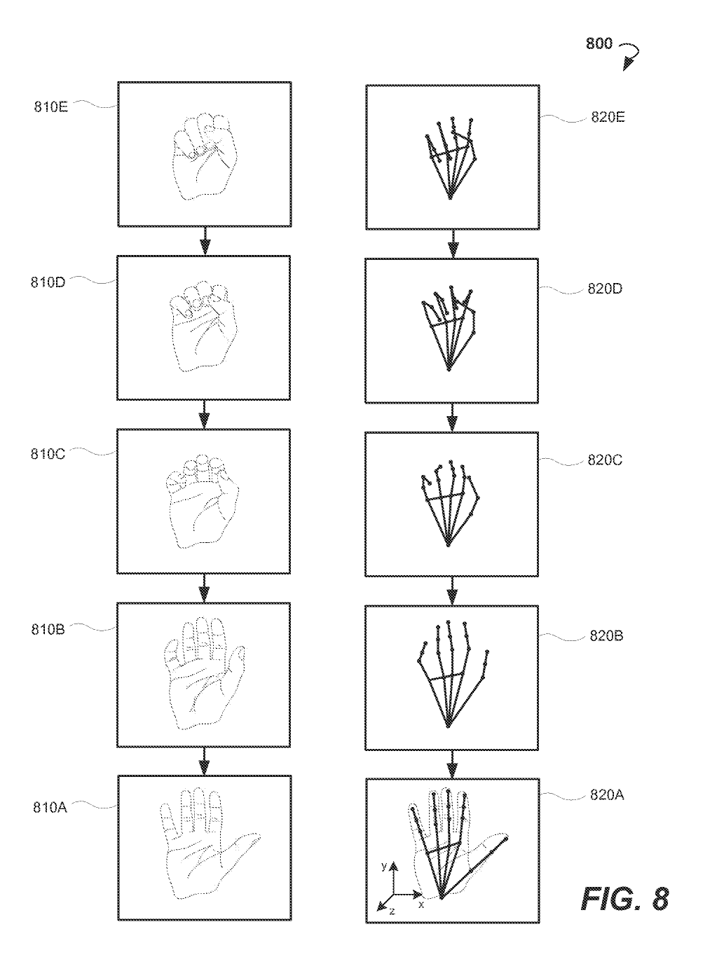

In an alternative example embodiment, the technology may first pre-process the images to build a virtual skeleton. FIG. 8 shows the same series of images 810E-810A capturing a similar gesture as depicted in FIG. 6, but now represented as a set of virtual skeleton hand postures 820E-820A, respectively, wherein virtual skeleton posture 820E represents (or transforms) image 810E, and so forth for images 810D-810A and skeletons 820D-820A. Accordingly, 3D user-gesture data can refer to a set of characteristics of one or more virtual skeleton postures and/or its parts or geometric elements. There are shown several parameters that can be associated with a virtual skeleton. For example, features extracted from the virtual skeleton may relate to, but are not limited to, 3D coordinates of virtual skeleton joints, relative positions of virtual skeleton interconnects (i.e., bones), angles between the virtual skeleton interconnects, absolute dimensions of the virtual skeleton interconnects, relative dimensions of the virtual skeleton interconnects, velocity or acceleration of motions made by the virtual skeleton interconnects or joints, and/or direction or motion patterns made by the virtual skeleton interconnects or joints.

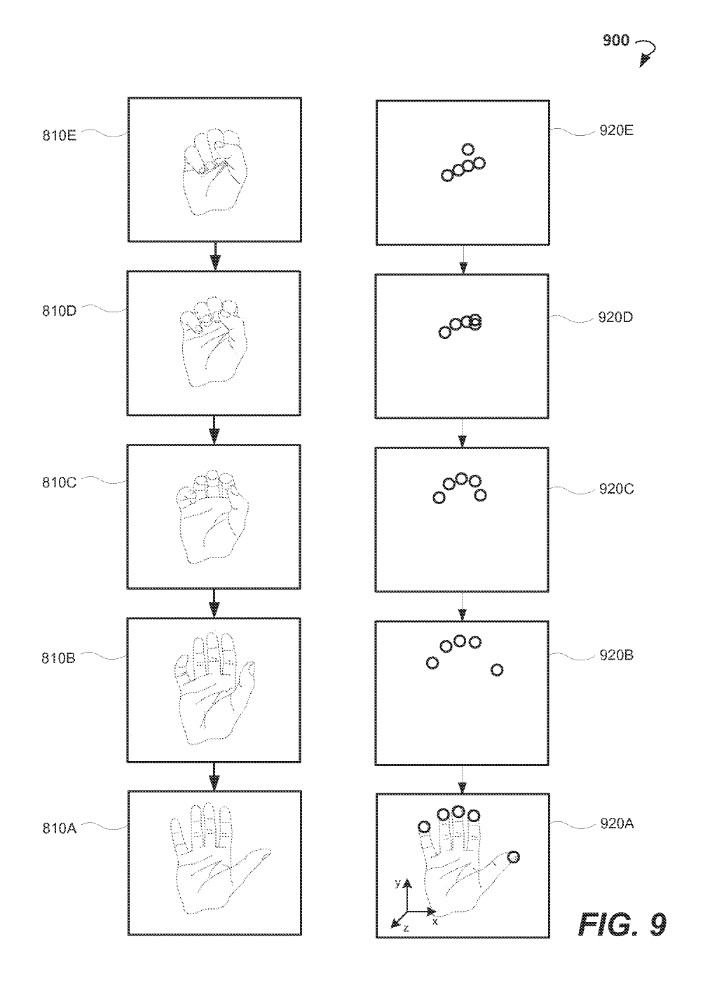

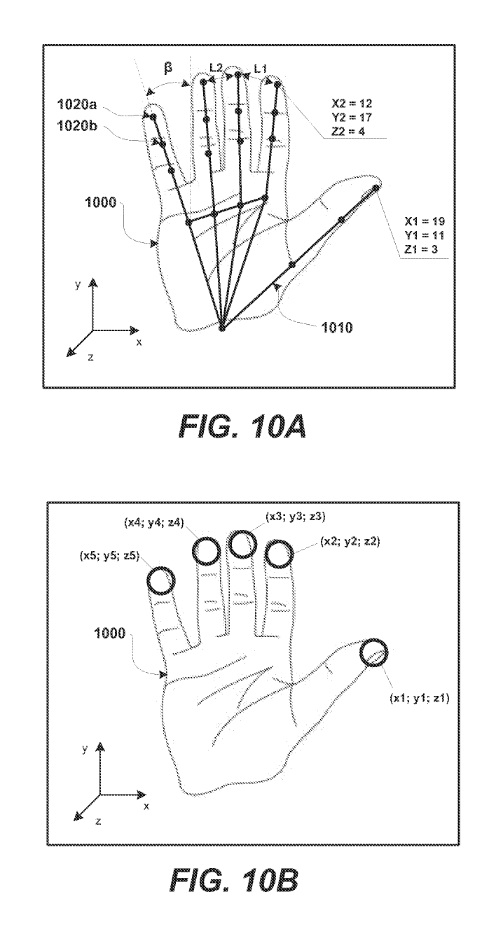

In yet another example embodiment, the technology can pre-process the images to recognize finger cushions, nails, or simply finger ends. Accordingly, the 3D hand gesture may be tracked by the motion of finger cushions. FIG. 9 shows the same images 810E-810A capturing a hand gesture as shown in FIG. 7 and FIG. 8, but now from a perspective of mappings of positions of finger cushions 920E-920A. As shown in FIG. 10A for virtual skeleton features and in FIG. 10B for every finger cushion, coordinates can be calculated and tracked. When the coordinates of the skeleton features and/or the finger cushions are combined together, for example, and analyzed as a progressive series of positions, there can be determined velocities, accelerations, respective position of fingers or finger cushions, postures, lengths, dimension ratios, angles between certain elements, motion patterns, and other derived elements, calculations or attributes. These data can constitute 3D hand gesture data, which may then be analyzed using machine learning algorithms to make an authentication decision and/or generate corresponding control commands. At least one preferred embodiment utilizes depth information with respect to individual fingers and/or elements, wherein such depth information is specified in a 3D coordinate system.

Referring still to FIG. 10A, there are shown a single snapshot of a user hand 1000 in the process of making a gesture and a virtual skeleton 1010 as can be generated by the authentication system 130. The virtual skeleton 1010 is implemented as a series of joints, such as 1020a, 1020b; and also a number of interconnects which virtually interconnect the joints 1020a, 1020b. The features associated with the hand posture shown may include, for example, 3D coordinates of some or all joints (in the shown example, there are presented 3D coordinates {x1, y1, z1} and {x2, y2, z2}. The features may also include dimensions of the interconnects. The features may also include relative positions of joints or interconnects, such as distances L1 and L2 between adjacent joints associated with different fingers. Further, some features may include angles like an angle between adjacent fingers or adjacent interconnects as shown.

Similarly, FIG. 10B shows a snap shot of user hand posture 1000, which when pre-processed may also include identified finger cushions (shown by bold circles in this FIG. 10B). The finger cushions can be identified as terminating joints of the virtual skeleton shown in FIG. 10B, although other techniques, such as image recognition process, for identifying the finger cushions can be used. In alternative embodiments, not only finger cushions but also finger nails may be identified. Accordingly, each finger cushion is associated with corresponding 3D coordinates {xᵢ, yᵢ, zᵢ}. In this example, there are five 3D coordinates corresponding to five fingers that constitute said features. In other embodiments, the number of 3D coordinates can be limited by another number.

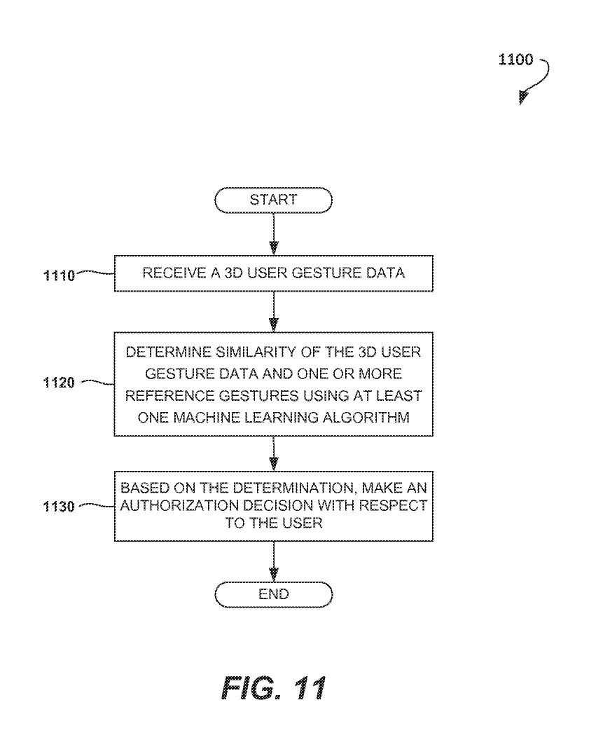

FIG. 11 illustrates the run-time process flow for a user authentication method 1100 according to at least one preferred embodiment. The method 1100 may be performed by processing logic that may comprise hardware (e.g., dedicated logic, programmable logic, and microcode), software (such as software run on a general-purpose computer system or a dedicated machine), or a combination of both. In one embodiment, the processing logic resides at the authentication system 130 and/or user device 110 (see at FIG. 1-FIG. 4).

Still referring to FIG. 11, and with continuing reference to FIG. 1-FIG. 5, the method 1100 may commence at step 1110, when the communication module 510 of the authentication system 130 receives 3D user-gesture data. As described above, the 3D user-gesture data can be derived from a series of snapshots or images captured by the sensor 115. In an example implementation, 3D user-gesture data is represented by a feature vector associated with the entire hand gesture made by a user. At operation 1120, the analyzing module 520 applies one or more machine learning algorithms to determine similarity between the 3D user-gesture data and one or more reference gestures. For example, the feature vector can be consequently compared to one or more pre-store reference feature vectors (being stored in the storage memory 540, for example), which relate to various pre-validated users and their corresponding gestures. The similarity can be characterized by a similarity value, which may be as simple as a difference vector between the feature vector and the most similar reference feature vector. When finding the similarity value of obtained feature vectors and pre-stored feature vectors, one or more machine learning algorithms can be used by the authorization system 130. In particular, authorization may use one or more of neural networks based algorithms, Support Vector Machine (SVM) algorithms, and k-nearest neighbor (k-NN) algorithms to determine similarity.

Still referring to FIG. 11, at step 1130, the authentication module 530 makes a corresponding authentication decision based on the similarity determination at the operation 1120. For example, if the similarity is higher than a predetermined threshold, a positive authentication decision can be made. Otherwise, a negative authentication decision can be made. Further, the authentication decision can be delivered by the communication module 510 to a requester such as the user device 110, local or remote resources 120, or other electronic devices or virtual software modules.

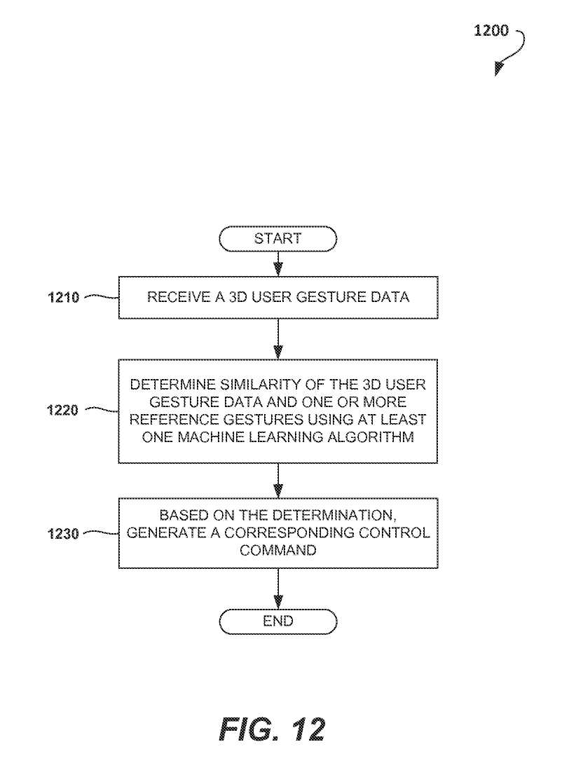

Referring to FIG. 12, in accordance with at least one preferred embodiment of the invention, a process flow diagram illustrates a series of steps of a method 1200 for controlling an electronic device based on 3D user-gesture data. The control method 1200 may be performed by processing logic that may comprise hardware (e.g., dedicated logic, programmable logic, and microcode), software (such as software run on a general-purpose computer system or a dedicated machine), or a combination of both. In one or more embodiments, the processing logic can reside at the user device 110 and/or at the authentication system 130 and/or a remote platform (see at FIG. 1-FIG. 4).

Still referring to FIG. 12, and with continuing reference to FIG. 1-FIG. 5, the method 1200 may commence at step 1210, when the authentication system 130 receives 3D user-gesture data that can be derived from snapshots or images captured by the sensor 115. At step 1220, the analyzing module 520 applies one or more machine learning algorithms to determine similarity between the 3D user-gesture data and one or more reference gestures. The similarity can be characterized by a similarity value, which can be as simple as a difference vector between a feature vector and a most similar reference feature vector, as previously described. Further, at step 1230, the authentication system 130 and/or the user device 110 generates a corresponding control command based on the similarity determination at the operation 1120. For example, if the similarity is higher than a predetermined threshold, a certain control command can be generated. Otherwise, a different control command, or no command, can be generated. Further, the control command, if any, can be delivered by the communication module 510 to a requester such as the user device 110, local or remote resources 120, or other electronic devices or virtual software modules. It should be also appreciated that the methods 1100 and 1200 can be combined together, i.e. a single hand gesture can be used to both authenticate a user and generate a control command (e.g., activate a user device).

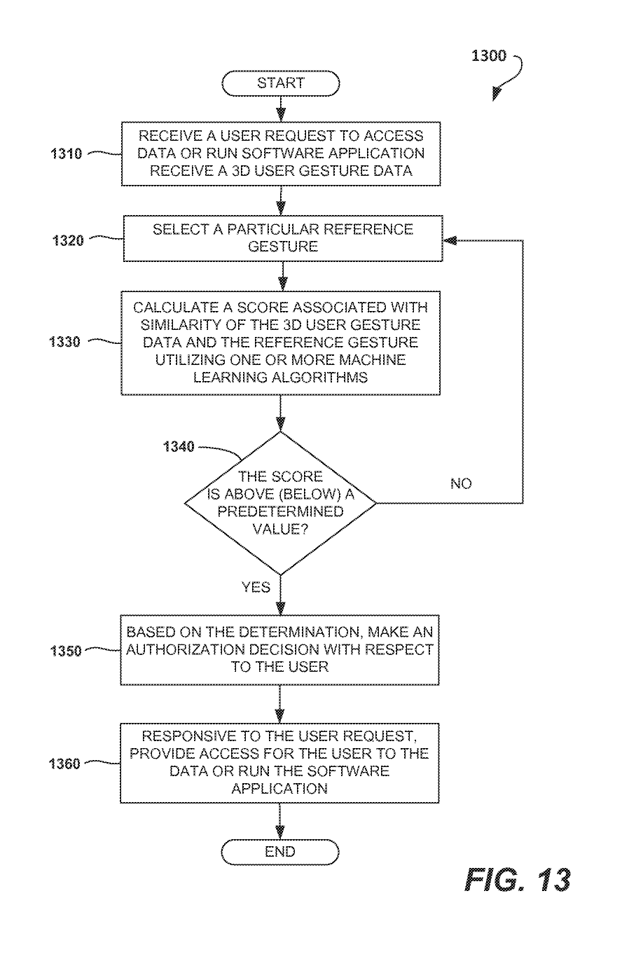

Referring now to FIG. 13, yet another preferred embodiment of the invention can provide for a method 1300 for providing a user access to data or authorization to run a software application. The access and/or authorization method 1300 can be performed by processing logic that can comprise hardware and/or software, as described above. In one or more embodiments, the processing logic can reside at the user device 110, the authentication system 130 or at a remote resource 120 (see at FIG. 1-FIG. 4).

Still referring to FIG. 13, and with continuing reference to FIG. 1-FIG. 5, the access and/or authorization method 1300 can start at step 1310, when the user device 110 or remote resource 120 receives a user request to access data or run a software application or activate hardware. This request can be communicated in the form of receiving 3D user-gesture data, or a user request to access data or run a software application can be made and thereafter 3D user-gesture data is received in conjunction with the request. At step 1320, the system (e.g., system 100, system 200, system 300 or system 400 in FIGS. 1-4, respectively) selects a particular reference gesture from stored memory 540. This selection may be based on the particular reference gesture having predetermined correspondence to the type of or specific data for which access has been requested or the type of or specific software application for which a run authorization has been requested. Alternatively, the selection of the particular reference gesture can be based on other criteria, such as, for example, without limitation, the 3D user gesture received at step 1310, or upon other criteria. This selection can be made via instructions in the analyzing module 520, in the authentication module 510, at remote resource 120, or otherwise in the user device 110.

Still referring to FIG. 13, and with continuing reference to FIG. 1-FIG. 5, at step 1330, the analyzing module 520 utilizes one or more machine learning algorithms to calculate a score associated with similarity between the 3D user-gesture data received and the particular reference gesture selected. At step 1340, the analyzing module 520 and/or the user device 110 evaluates whether or not the similarity score is above (or below) a predetermined value. If this evaluation step 1340 yields a positive result, then the method moves to authorization decision step 1350; but, if the evaluation step 1340 yields a negative result, then the method returns to step 1320. Upon return to step 1320, the method can call for selecting another particular reference gesture. As described above, this selection can be based on various criteria, which criteria can depend on alternative embodiments of the invention, on the user request or the 3D user-gesture data first received at step 1310, and/or on the score calculated at step 1330 (and/or how close the score is above or below the predetermined value). If the method 1300 reaches step 1350, then an authorization decision is made based on the positive result from evaluation step 1340. It will be appreciated that at step 1350 the method can allow either a positive or negative decision with respect to authorizing user access to data requested or to running the software application requested. Furthermore, the method according to one or more embodiments can make a further decision at step 1350 about which data to allow the user to access, if any, and/or which software to authorize the user to run, if any. If the authorization decision made at step 1350 is to authorize data access or to authorize running a software application, then at step 1360 the user device 110, the communication module 510 or a remote resource 120 can provide access for the user to the data or access to run the software application.

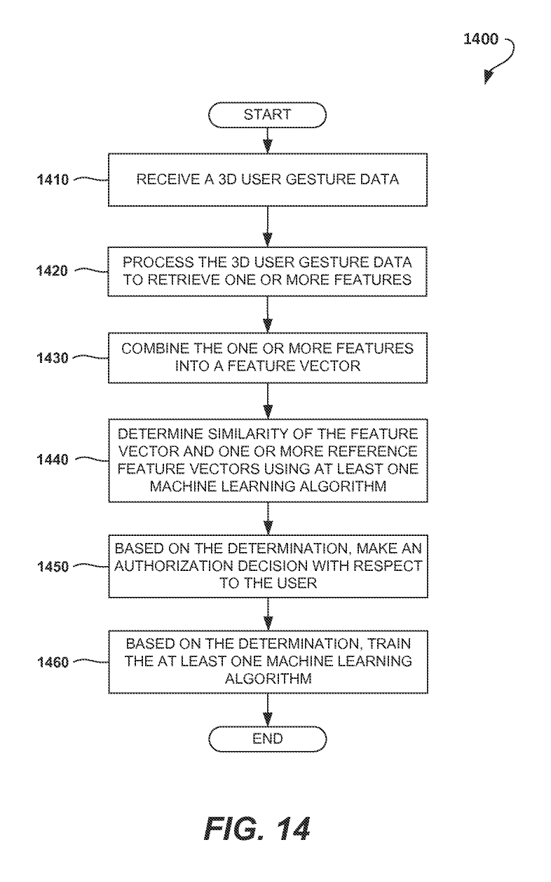

Referring to FIG. 14, a further embodiment provides for a method 1400 for training a machine learning algorithm upon receipt of 3D user-gesture data and processing thereof. At step 1410, the user device 110 or authentication system 130 receives 3D user-gesture data. At step 1420, the 3D user-gesture data is processed to retrieve one or more features from the data. In at least one example, these one or more features can be combined into a first feature vector in step 1430, which first feature vector can be associated with a user hand gesture related to the received 3D user-gesture data. At step 1440, the analyzing module 520 applies one or more machine learning algorithms to determine similarity between the first feature vector that is associated with the user hand gesture (and/or the received 3D user-gesture data) and one or more second, reference feature vectors. It will be appreciated that these second, reference feature vectors can be associated with (e.g., can correspond to) one or more reference user gestures or with one or more instances of reference 3D user-gesture data. For example, the first feature vector can be compared to one or more pre-stored second reference feature vectors (being stored in the storage memory 540), which second reference feature vectors can relate to various pre-validated users and their corresponding gestures. The similarity can be characterized by a similarity value, which may be as simple as a difference vector between the first feature vector and the most similar second, reference feature vector. Further, based on the similarity determination at step 1440, the authentication module 530 and/or the analyzing module 520, at step 1450, can make a corresponding authorization decision with respect to the user. For example, if the similarity is higher than a predetermined threshold, a positive authorization decision can be made. Otherwise, a negative authorization decision can be made. At step 1460, the method 1400 calls for training the at least one machine learning algorithm based on the similarity determination. Accordingly, each time the particular user goes through the authorization procedure as described herein, the machine learning algorithms used may be trained, thereby increasing the accuracy of the authentication methods.

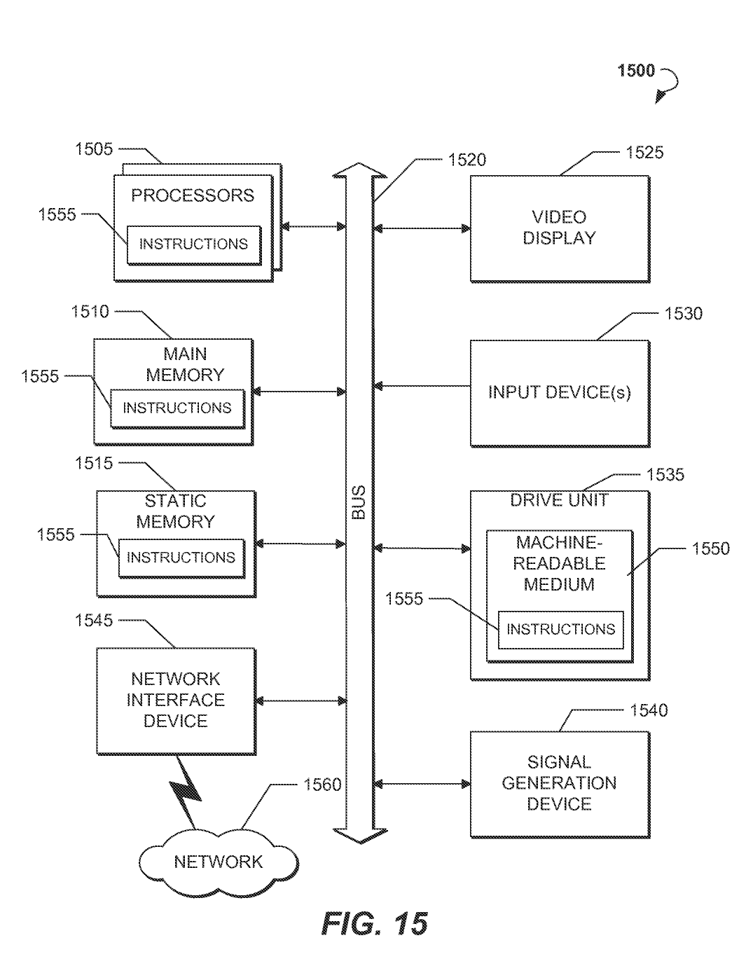

FIG. 15 shows a diagrammatic representation of a computing device for a machine in the example electronic form of a computer system 1500, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a personal computer (PC), tablet PC, cellular telephone, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein.

The example computer system 1500 includes a processor or multiple processors 1505 (e.g., a central processing unit (CPU), a graphics processing unit (GPU), or both), and a main memory 1510 and a static memory 1515, which communicate with each other via a bus 1520. The computer system 1500 can further include a video display unit 1525. The computer system 1500 also includes at least one input device 1530, such as, without limitation, an alphanumeric input device (e.g., a keyboard), a cursor control device (e.g., a mouse), a microphone, a digital camera, a video camera, a touchpad, a touchscreen, and/or any other device or technology enabling input. The computer system 1500 also includes a disk drive unit 1535, a signal generation device 1540 (e.g., a speaker), and a network interface device 1545.

The disk drive unit 1535 includes a computer-readable medium 1550, which stores one or more sets of instructions and data structures (e.g., instructions 1555) embodying or utilized by any one or more of the methodologies or functions described herein. The instructions 1555 can also reside, completely or at least partially, within the main memory 1510 and/or within the processors 1505 during execution thereof by the computer system 1500. The main memory 1510 and the processors 1505 also constitute machine-readable media.

The instructions 1555 can further be transmitted or received over a communications network 1560 via the network interface device 1545 utilizing any one of a number of well-known transfer protocols (e.g., Hyper Text Transfer Protocol (HTTP), CAN, Serial, and Modbus). The communications network 1560 may include or interface with the Internet, local intranet, PAN (Personal Area Network), LAN (Local Area Network), WAN (Wide Area Network), MAN (Metropolitan Area Network), virtual private network (VPN), a cellular network, Bluetooth radio, an IEEE 802.11-based radio frequency network, a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), or RIM (Research in Motion, Limited) duplex paging network, or any other network capable of communicating data between devices. The network 1560 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

While the computer-readable medium 1550 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. (including, for example, without limitation, iOS or the Android operating systems). Although not limited thereto, computer software programs for implementing the present method can be written in any number of suitable programming languages such as, for example, without limitation, Hypertext Markup Language (HTML), Dynamic HTML, XML, Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, .NET, Adobe Flash, Perl, UNIX Shell, Android IDE, Visual Basic or Visual Basic Script, Virtual Reality Markup Language (VRML), Javascript, PHP, Python, Ruby, ColdFusion™ or other compilers, assemblers, interpreters, or other computer languages, coding frameworks, or development platforms.

While the present invention has been described in conjunction with preferred embodiment, one of ordinary skill, after reading the foregoing specification, will be able to effect various changes, substitutions of equivalents, and other alterations to the system components and methods set forth herein. It is therefore intended that the patent protection granted hereon be limited only by the appended claims and equivalents thereof.

What is claimed is:

1. A method, comprising:
receiving, by one or more processors, three dimensional (3D) user gesture data corresponding to at least one of a user gesture and a user hand, wherein the 3D user-gesture data includes at least one of 3D hand shape data and 3D hand positional data acquired over a period of time;
determining, by the one or more processors, similarity of the 3D user-gesture data and one or more reference gestures; and
based on the determined similarity, making, by the one or more processors, an authorization decision with respect to the user.

2. The method of claim 1, wherein the at least one of hand shape data and hand positional data comprises a set of images associated with a user hand taken over the period of time.

3. The method of claim 1, wherein the at least one of hand shape data and hand positional data comprises a set of depth maps associated with a user hand taken over the period of time.

4. The method of claim 1, wherein the at least one of 3D hand shape data and 3D hand positional data comprises a set of fingers posture data associated with a user hand taken over the period of time.

5. The method of claim 1, wherein the at least one of 3D hand shape data and 3D hand positional data comprises a set of finger cushions posture data associated with user hand taken over the period of time.

6. The method of claim 1, wherein the at least one of 3D hand shape data and 3D hand positional data comprises a set of coordinates within a 3D coordinate system, wherein the set of coordinates are associated with the user hand.

7. The method of claim 1, wherein the at least one of 3D hand shape data and 3D hand positional data comprises a set of coordinates within a 3D coordinate system, wherein the set of coordinates are associated with hand fingers or finger cushions.

8. The method of claim 1, wherein the step of determining similarity of the 3D user-gesture data and one or more reference gestures further comprises processing the 3D gesture data by a machine learning algorithm, wherein the machine learning algorithm comprises one or more heuristic algorithms, one or more support vector machines, one or more neural network algorithms, or a combination thereof.

9. The method of claim 8, further comprising the step of training the machine learning algorithm every time the user has successfully authorized.

10. The method of claim 1, wherein the step of determining similarity of the 3D user-gesture data and one or more reference gestures further comprises calculating a score associated with the similarity, and wherein the step of making an authorization decision with respect to the user further comprises comparing the score with a predetermined value.

11. The method of claim 1, wherein the 3D user-gesture data is associated with a user gesture of splaying fingers or making a fist.

13. The method of claim 1, wherein the 3D user-gesture data is associated with a user gesture of making a finger snap motion.

14. The method of claim 1, wherein the 3D user-gesture data is associated with a user gesture of rotating a hand.

15. The method of claim 1, wherein the 3D user-gesture data is associated with a user gesture of making moving a user hand towards a depth sensor.

16. The method of claim 1, wherein the 3D user-gesture data is associated with a user gesture of making a circle motion.

17. The method of claim 1, wherein the 3D user-gesture data further comprises one or more attributes associated with a gesture made by the user's hand or fingers of the user's hand, wherein the attributes further comprise one or more of a velocity, an acceleration, a trajectory, and a time of exposure.

18. The method of claim 17, further comprising the step of determining, by the one or more processors, that the one or more attributes refer to one or more reference attributes.

19. The method of claim 1, further comprising the step of determining, by the one or more processors, that the user gesture was made within a predetermined distance from a sensor.

20. A method, comprising:
receiving, by one or more processors, a user request to access data or run a software application;
receiving, by the one or more processors, an element of 3D user-gesture data, wherein the 3D user-gesture data comprises data related to a set of hand and/or finger postures captured over a period of time, and wherein the 3D user-gesture data further comprises data related to a set of 3D coordinates that correspond to hand or finger postures captured over the period of time;
calculating, by the one or more processors and utilizing one or more machine learning algorithms, a score associated with similarity of the 3D user-gesture data and one or more reference gestures;
determining, by the one or more processors, that the score is above or below a predetermined value;
based on the score determination, making, by the one or more processors, an authorization decision with respect to the user; and
responsive to the user request, providing, by the one or more processors, access for the user to the data or to run the software application.

21. A method for controlling an electronic device, the method comprising the steps of:
receiving, by the one or more processors, an element of 3D user-gesture data, wherein the 3D user-gesture data comprises data related to a set of hand and/or finger postures captured over a period of time, and wherein the 3D user-gesture data further comprises data related to a set of 3D coordinates that correspond to hand or finger postures captured over the period of time;
calculating, by the one or more processors and utilizing one or more machine learning algorithms, a score associated with similarity of the 3D user-gesture data and one or more reference gestures;
determining, by the one or more processors, that the score is above or below a predetermined value;
based on the score determination, making, by the one or more processors, an authorization decision with respect to the user; and
based on the determination of similarity, generating, by the one or more processors, a control command for the electronic device.

22. The method of claim 21, wherein the control command is configured to change an operation mode of the electronic device from an idle state to an operational mode.
